(19) United States
(12) Patent Application Publication
(10) Pub. No.: US 2025/0185532 A1
(43) Pub. Date: Jun. 12, 2025

(54) Systems And Methods For Use In Planting Seeds In Growing Spaces

(71) Applicant: CLIMATE LLC, Saint Louis, MO (US)

(72) Inventors: Morrison JACOBS, Saint Charles, MO (US); Nikisha SHAH, North Brunswick, NJ (US); Shilpa SOOD, Apex, NC (US)

(21) Appl. No.: 18/969,235

(22) Filed: Dec. 4, 2024

Related U.S. Application Data
(60) Provisional application No. 63/607,041, filed on Dec. 6, 2023.

(51) Int. Cl. A01C 21/00

(52) U.S. Cl. CPC A01C 21/00

(57) ABSTRACT

Systems and methods are provided for use in identifying candidate seeds. An example computer-implemented method includes receiving, from a user, at a computer system, a request for a seed recommendation for a plurality of fields; identifying, by the computer system, multiple seeds and volumes for the multiple seeds to be planted in the plurality of fields, the multiple seeds included in a rank-ordered listing of ones of the multiple seeds for each of the plurality of fields; generating, by the computer system, a planting recommendation to plant the multiple seeds from the listing in the plurality of fields as a planting recommendation, based on an objective function, the objective function indicative of yield, multiple relative maturity thresholds, and one or more operational rules; and outputting, by the computer system, the planting recommendation of the seeds to the user associated with the fields, in response to the request.

### CROSS-REFERENCE TO RELATED APPLICATION

This application claims the benefit of, and priority to, U.S. Provisional Application No. 63/607,041, filed Dec. 6, 2023, the entire contents of which are hereby incorporated by reference.

### FIELD

The present disclosure generally relates to systems and methods for use in planting seeds in growing spaces and harvesting crops associated with the seeds.

### BACKGROUND

This section provides background information related to the present disclosure which is not necessarily prior art.

It is known for seeds to be grown in fields for commercial purposes, whereby the resulting plants, or parts thereof, are sold by the growers for business purposes and/or profit. For example, corn may be grown by a farmer in a field owned, leased, or managed by the farmer, and the corn grown and harvested from the field is then sold (e.g., for consumption by livestock, etc.). Consequently, farmers and other growers often seek to plant particular seeds based on specific aims of the farmers (e.g., corn versus soybeans, etc.), specific climate conditions of the fields (e.g., drought tolerance, etc.), specific disease resistance, and also, based on performance of the seeds in terms of yield. Farmers may rely on past performance of seeds in their fields, or on recommendations based on conditions of their fields, by seed providers, in selecting seeds for planting.

### SUMMARY

This section provides a general summary of the disclosure and is not a comprehensive disclosure of its full scope or all of its features.

Example embodiments of the present disclosure generally relate to computer-implemented methods for use in identifying candidate seeds (e.g., for planting in a field, etc.). In one example embodiment, such a method for identifying candidate seeds generally includes receiving, from a user, at a computer system, a request for a seed recommendation for a plurality of fields; identifying, by the computer system, multiple seeds and volumes for the multiple seeds to be planted in the plurality of fields, the multiple seeds included in a rank-ordered listing of ones of the multiple seeds for each of the plurality of fields; generating, by the computer system, a planting recommendation to plant the multiple seeds from the listing in the plurality of fields as a planting recommendation, based on an objective function, the objective function indicative of yield, multiple relative maturity thresholds, and one or more operational rules; outputting, by the computer system, the planting recommendation of the seeds to the user associated with the fields, in response to the request; and including at least one seed from the planting recommendation in one of the plurality of fields.

Example embodiments of the present disclosure generally relate to systems for use in identifying candidate seeds (e.g., for planting in a field, etc.). In one example embodiment, such a system for use in identifying candidate seeds generally includes at least one computing device configured to: receive, from a user, a request for a seed recommendation for a plurality of fields; identify multiple seeds and volumes for the multiple seeds to be planted in the plurality of fields, the multiple seeds included in a rank-ordered listing of ones of the multiple seeds for each of the plurality of fields; generate a planting recommendation to plant the multiple seeds from the listing in the plurality of fields as a planting recommendation, based on an objective function, the objective function indicative of yield, multiple relative maturity thresholds, and one or more operational rules; and output the planting recommendation of the seeds to the user associated with the fields, in response to the request.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for accessing data related to growing spaces and historical selection data from one or more growers, for use in recommending seeds to be planted in numerous fields;

FIG. 2 illustrates an example model architecture, which may be implemented in the system of FIG. 1;

FIG. 3 illustrates an example method that may be used in the system of FIG. 1 to recommend seeds to be planted in numerous fields;

FIGS. 4A-4B are block diagrams that illustrate example computer systems upon which one or more embodiments of the present disclosure may be implemented; and

FIG. 5 illustrates an example implementation architecture that may be included and/or implemented in a computer system of FIG. 1 and/or FIGS. 4A-4B, for use in performing one or more of the functions described herein.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Seeds to be planted in target fields (broadly, growing spaces) are manually selected by growers (broadly, users) based at least in part on the suitability of the seeds to the fields (or to one or more representative fields). Through years of growing selected seeds in the target fields and related performance, it may be apparent that planting decisions may not always be based on objective data related to the seeds, the fields, etc. In this way, the performance of the seeds and/or fields is impacted by biases or other logic applied by growers in manually selecting seeds. As such, the seed placement decisions of growers may provide inefficiencies in crop productions.

Uniquely, the systems and methods herein provide for defining planting recommendations for fields, whereby specific objective criteria are imposed on the planting recommendations to promote yield performance of the fields, while limiting exposure of the fields and considering grower preferences.

In particular, in connection with planting recommendations, modeling is employed, which takes into consideration grower operation size and spread, potential yield gain, and/or exposure considerations to generate the recommendation that is planting and harvest operational friendly. This is achieved by recommending similar seeds (e.g., hybrids, etc.) of similar/same relative maturity and/or type in nearby fields, to aid in user efficiencies in travel between fields, in planting and then also in harvest. In one example, clustering is employed to facilitate similar relative maturity assignments for nearby fields, whereby nearby fields are grouped into geographical clusters by taking into consideration distance between fields and also, potentially, field size. In connection with the above, based on a listing of seeds probable to perform the fields of the grower operation, optimization is then employed, through an objective function, to determine the specific recommendation of seeds in the fields of a grower operations. The objective function, as described below, weighs yield performance, operational considerations, products supply, and exposure of the fields (e.g., maturity risk, risk of disease, etc.). The recommendation is then output to the grower operation and implemented, whereby enhanced performance is provided over conventional techniques for seed placement.

Optionally, in order to address deficiencies in conventional modeling, the architecture herein breaks down the overarching problem of generating planting recommendations (and/or plans) into multiple problems to solve iteratively, by applying multiple heuristic approaches and/or valid inequalities to further simplify each smaller problem. In this way, available optimization solvers are usable to generate product-to-field recommendations that consider grower preferences, agronomic factors and exposures, and seed performance as to enhance yield, enhance return on investment, and/or limit uncertainly or exposure.

It should be understood that the optimization herein is usable in any suitable size grower operation, but is especially useful for grower operation that include more than ten (10), more than thirty (30) or more than fifty (50) fields and/or covering hundreds or more acres (and spread out over hundreds or thousands or more acres), with dozen(s) or more seeds to be placed in the fields.

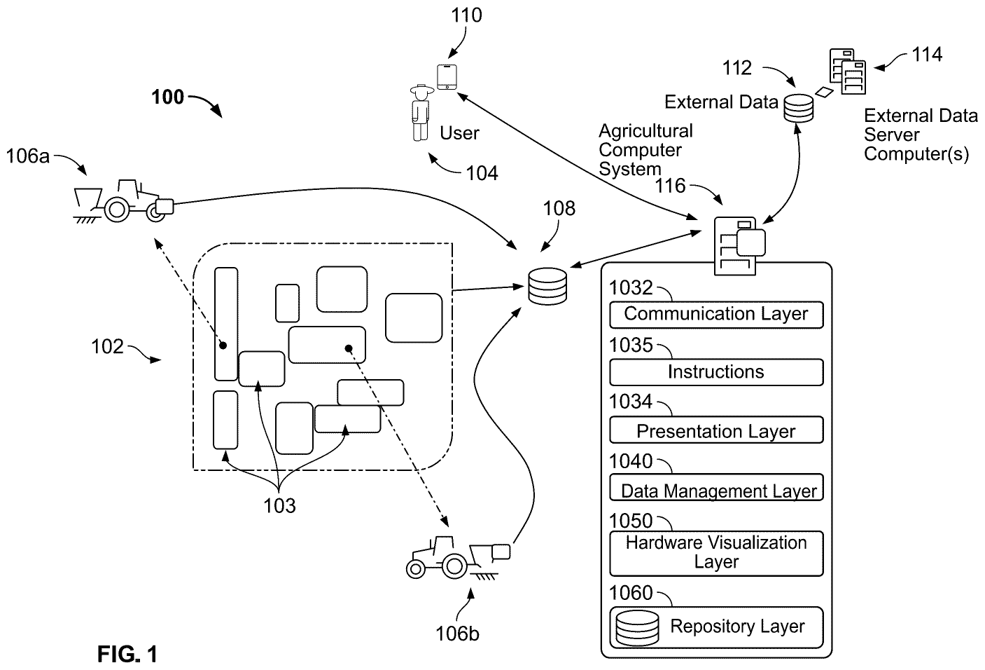

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, relationships between users, farm equipment and fields; data flows; types of crops included in fields; types and/or locations of fields; planting and/or harvest activities; privacy and/or data requirements; etc.

As shown, the system 100 generally includes a grower operation 102, which is divisible into different fields 103. The fields 103 is generally representative of thirty fields in this example, although the fields 103 may include more, many more or less in other embodiments. The fields 103 may be distributed through a region, whereby some fields 103 may be adjacent to one another, while other fields 103 are spaced apart from one another (e.g., by one or more miles, etc.). In general, the fields 103 are owned, operated and/or managed by the user 104. In this way, the user 104 may include a farmer, or a grower business or entity, which is in the business of planting, growing, harvesting and selling the crops. As such, the user 104 is a person, or group of people or a business, which is/are responsible for making decisions related to the fields 103. For example, the user 104 may decide what different seeds and/or volumes of the same to plant within the fields 103, what management practices to employ on some or all of the fields 103, and when to harvest the crop, etc.

Again, it should be appreciated that the user 104 may be associated with dozens, or hundreds, or even thousands of fields 103, depending on, for example, the type of user 104 and/or grower operation 102. It should also be appreciated that planting, management, and harvesting decisions are made by the user 104 for the specific fields 103, whereby the decisions may be different for different ones of the fields 103.

In the illustrated system 100, the fields 103 in the grower operation 102 historically have been planted and harvested, whereby data (e.g., agronomic data, etc.) is gathered at or from the grower operation 102. The data may be gathered manually, or automatically, for example, by farm equipment, etc. The data may include plant/seed identifiers, plant/seed types, planting dates, location data, field identifiers, soil conditions, plant performance (e.g., height, strength, yield, etc.) (e.g., at one or more regular or irregular interval(s), etc.), plant growth stages, treatments, weather conditions, and other suitable data to identify the seed/plant and/or a performance of the seed/plant, etc.

In addition to the grower operation 102 in FIG. 1, the system 100 also includes a number of agricultural equipment (e.g., equipment 106a-b, etc.), a data server 108 (or multiple data servers), and an agricultural computer system 116, each of which is coupled to (and is in communication with) one or more network(s). The network(s) is/are indicated generally by arrowed lines in FIG. 1, and may each include, without limitation, one or more of a local area network (LAN), a wide area network (WAN) (e.g., the Internet, etc.), a mobile/cellular network, a virtual network, and/or another suitable public and/or private network capable of supporting communication among parts of the system 100 illustrated in FIG. 1, or any combination thereof.

In this example embodiment, the agricultural equipment includes a planting device 106a and a planting device 106b, each disposed in one of the fields 103 in the grower operation 102. Nonetheless, it should be also appreciated that different numbers and/or types of planting devices, which may be distributed differently among the different growing spaces, may be included in other system embodiments.

The planting devices 106a-b may include, for example, planters or other mechanisms for planting seeds in the grower operation 102, or fields 103 thereof in FIG. 1. The planting devices 106a-b may be fully or partially automated (e.g., via a script, etc.), and/or reliant, at least in part, on a human operator, etc. The planting devices 106a-b, in general, are configured to disturb the soil in the fields 103, place a seed, and repeat at one or more planting speeds, etc., whereby the fields 103 are planted. In connection therewith, the planting devices 106a-b are configured to compile data specific to the seed(s) being planted and to the operation of planting, etc. The data may include, without limitation, planting location, seed density, spacing, rate, or other suitable data, etc. It should be appreciated that while planting devices 106a-b are illustrated in FIG. 1, the agricultural equipment in the grower operation 102 may also include sprayers, irrigation, harvesting devices, etc., which, likewise, are configured to compile relevant data (e.g., yield, location, treatments, etc.).

Each of the planting devices 106a-b is further configured to transmit the gathered data to the data server 108, depending on the particular growing space(s) for which the data relates. That said, a different number of data servers 108 may be included in other system embodiments, with the different data servers 108 each being specific to fields 103 of the grower operation 102, or not.

The data server 108, in turn, is configured to store the received data in one or more data structures. In general, in this example embodiment, the data server 108 is configured to store data by year (e.g., Year Y−1, Year_Y, Year_Y+1, etc.), which corresponds to the different growing years (e.g., 2020, 2021, 2022, etc.) for the grower operation 102 (and/or plots, fields 103, etc. within the grower operation 102, etc.). Then, for each year, the data structure(s) of the data server 108 will include the data for each of the fields 103 and/or grower operation 102, seeds, harvested plants, etc. For example, for each field designation or identifier, the data structure(s) of the data server 108 may include an identifier for each seed planted in fields 103 in the given year, for brands for seeds, for relative maturity, for types of insect protection traits, for seed treatment years, for positions/distributions of seeds in the fields 103 of the grower operation 102, for location definitions of or within the fields 103 of the grower operation 102, for acreage of the fields 103 of the grower operation 102, for populations of seeds planted in the fields 103 of the grower operation 102, for average yields and harvest grain moisture (e.g., based on location and seed products, etc.), etc. The data may also include soil conditions, field elevations, precipitation amounts, irrigation amounts, or any other data indicative of the growing conditions for the seeds/plants in the given fields 103 of the grower operation 102, etc. It should be appreciated that any available and/or desired data may be collected with regard to plots, fields 103, etc., in different growing spaces and/or the seeds planted therein.

The data included in the data structure(s) of the data server 108 may be augmented with additional information about seeds from one or more other sources, including, for example, a category of the seeds (e.g., from a breeding pipeline provided to create new plants by crossing existing pools of parents, from a commercial pipeline provided to commercialize desired products and sell such products to consumers, etc.) (e.g., relative maturity, etc.), a product name, a trade name, a source name, etc.

As the season is concluded, and a next season is planned, decisions are to be made regarding the planting of seeds in the grower operation 102.

In connection therewith, in this example embodiment, the agricultural computer system 116 is configured to compile a listing of seeds for the fields 103 and then to compile a field placement for the seeds into the fields 103, which is a recommendation to the user 104 for the placement of the seeds in the fields 103 or the grower operation 102. Initially, the agricultural computer system 116 is configured to determine a number of products and a volume of the products to be planted in the fields 103. This may be based on input from the user 104 and/or a provider and/or producer of the seeds, in general or based on data related to the grower operation 102.

Specifically, the agricultural computer system 116 is configured to access data related to the fields 103 and potential seeds to be planted in the fields 103. The data may include, without limitation, weather data for the fields 103 (e.g., temperature, precipitation, etc.) and associated data such as, for example, relative maturity and stress risks, etc. The data may also include soil data, such as, for example, elevation, textures, CEC data, and also environmental data including, for example, disease risk, pest risk, etc. The data may include management practices such as, for example, crop rotation, tillage, planting, etc., and also genetic data, such as, for example, traits, disease resistance, disease susceptibility, etc. The input data may be defined at the field level or, potentially, at the regional level (e.g., county-level, etc.), etc. For example, genotype-by-environment (GxE) features may be included at the field level or the county level, or some other level of granularity, etc.

In addition, the accessed data may include seed details, such as, for example, identifier, trait data, disease resistance, etc. for one or more of the commercially available seeds, from which the user 104 is selecting seeds to be planted in the fields 103.

By considering the above data, in whole or in part, the agricultural computer system 116 is configured to predict the yield for certain seeds in certain fields 103, etc., which considers each of the fields 103, for which a crop is to be planted. This may be accomplished through a model such as described in U.S. patent application Ser. No. 16/845,052, filed Apr. 9, 2020 and U.S. patent application Ser. No. 16/662,369, filed on Oct. 24, 2019. For example, input data may be combined in a model to provide a predictive seed placement selection (e.g., corn placement selection, etc.), which includes a selection of specific seeds and also a volume of each. The model may include, without limitation, one or more of Elastic Net, Support vector regression, Hist GBM, and TabNet models, etc. In one specific embodiment, the model is an Elastic Net yield model. The model is trained and validated based on various techniques, including, for example, the leave-one-year-out (LOYO) cross validation strategy, etc.

Once the model is trained and validated, the agricultural computer system 116 is configured, by the trained model, to predict the yield, on a field basis, for each of the potential seeds to be planted in the fields 103.

This is an improvement over a region-wise prediction. Based on the above, the agricultural computer system 116 is further configured, by the trained model, to output the listing of seeds and associated volumes of the seeds for the user 104, where the seeds are listed in order of performance in fields consistent with the fields 103 being planned for (as indicated by rank relative to one another). For example, where the grower operation 102 included thirty fields 103, the listing includes a list of rank-ordered hybrids (e.g., three, five, seven, etc. hybrids, etc.) per field for each of the thirty fields 103. It should be understood that the listing may include more seeds for some fields 103, and less seeds for other fields 103 depending on the particular performance and/or associated threshold (e.g., to be include din the listing, etc.), or may include the same number of seeds for each of the fields 103 of the grower operation 102.

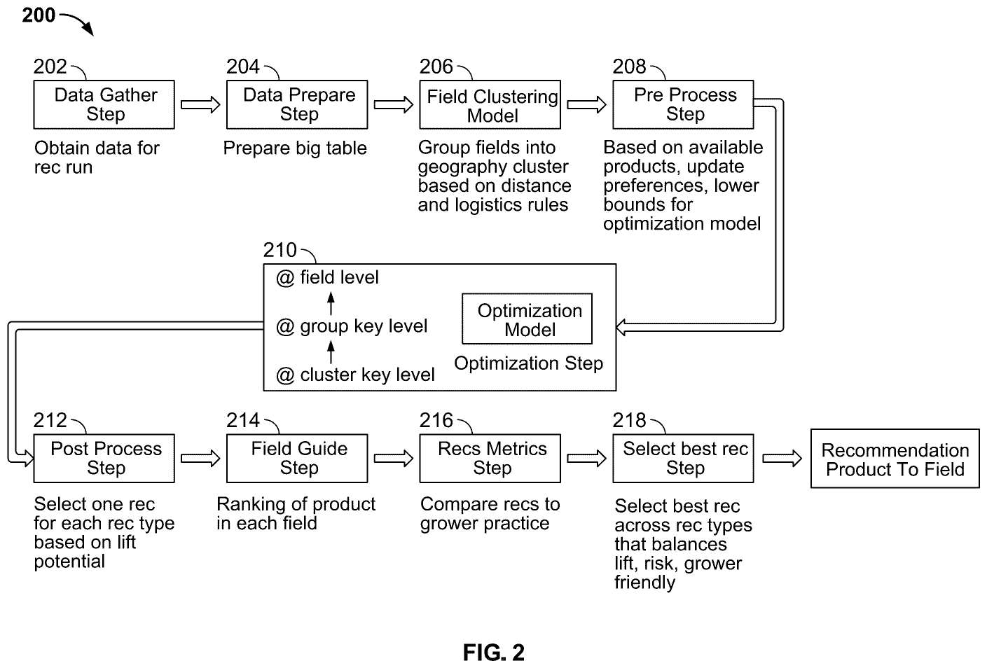

Next, the agricultural computer system 116 is configured to optimize assignment of the seeds from the listing to the different ones of the fields 103 as a recommendation. In connection therewith, as shown in FIG. 2, the agricultural computer system 116 is configured consistent with an objective function. In this exemplary embodiment, as provided below, the objective function is configured to enhance yield for the grower operations 102, while limiting the potential exposure of the crops and accounting for grower instruction, preferences, and/or constraints.

In this exemplary embodiment, the architecture 200 defines multiple different inputs to be considered in assigning the seeds. The inputs include, without limitation, field data, harvest risk data, disease and insect exposures, manage exposures, operational efficiencies and grower/user preferences. It should be understood that other input data may also be considered, as appropriate, in other example embodiments.

The field data includes an ordered listings of the seeds for the given field(s) 103 based on the above, i.e., a right seed, as defined by the seed placement model above. The harvest risk includes the relative maturity spread for the planting and the as experienced relative maturity (AERM) risk, which defines risk of the product not reaching physiological maturity before fall frost, for example. The disease and insect risk includes the genetic risk data associated with the seed, and the insect risk includes specific insect risks (e.g., high corn root worm, etc.). The manage risk data includes a limitation of the number of seeds per field, whereby multiple seeds may be required. The operational efficiencies take into account the relative locations to which the seeds are distributed, RM spread, and minimum number of bags, etc. And, finally, the grower/user preferences may include operational preferences, field level preferences, and/or product preferences, etc.

As indicated above, the model architecture 200 of FIG. 2 configures the agricultural computer system 116 to determine the recommended assignment of the seeds to the fields 103.

In particular, as shown in FIG. 2, the model architecture 200 includes a data gathering operation 202, in which the above input data is read and returned as a dictionary of data (as appropriate) to be used in the subsequent operations. The model architecture 200 includes a data prepare operation 204, which configures the agricultural computer system 116 to define grower preferences (e.g., based on historical data from the last N years, etc.) and to compile the read input data, or subsets of the input data (e.g. data features, etc.) into a common data structure (e.g., a single table, etc.). In addition, the data prepare operation 204 also configures the agricultural computer system 116 to identify the enrolled fields (e.g., one or more of the fields 103 in the grower operation 102, etc.) for which the recommendation is requested, along with the available products, product predictions (e.g., predicted yield, probability of success, etc.), product AERM risk, seeding rates for the fields 103, etc.

It should be appreciated that, through the data prepare operation 204, the field(s) 103 with missing or omitted data, or products with missing or omitted data, may be removed from the common data structure.

Next, the model architecture 200 includes a field clustering model 206, which configures the agricultural computer system 116 to cluster the fields 103, based on heuristics, into groups based on distance therebetween, size of the fields (or parts thereof), and any applicable logistic rules.

The model architecture 200 further includes a pre-process operation 208, which configures the agricultural computer system 116 to update preferences and lower bounds for the agricultural computer system 116. This may include any suitable operation(s) to further prepare the input data to be input to and/or handled by the objective function described below.

With continued reference to FIG. 2, the model architecture 200 is configured to maximize the objective function provided below. In general, the objective function incudes positive terms, which contribute to the performance of the grower operation 102 and negative terms, which may detract from the performance of the grower operation 102, as described more below.

$$max \{ - ObjSlcPFrc + ( ObjYld + ObjGdPrdFld - ObjMtrRsk 1 - ObjMtrRsk 2 - ObjMtrRsk 3 - Obj Late RmExt - ObjErlRmExt - ObjPrdCapSlc ) - ObjPltySlc - ObjPltyOprulSlc \}$$

The objective function is based on key group product fraction slack, yield of each operation, high performing products in high performing fields, maturity risk relative to one or more thresholds (e.g., safe, upper, etc.), early or late relative maturity, product cap slack, penalties for operation rules violations, and operational rules slack, etc., which are further defined in the expressions below. The objective function, when maximized, among the potential placements defines an optimized recommendation for the placement of seeds, in specific volumes, in the fields 103.

In this exemplary embodiment, the objective function is defined based on the following additional expressions (1)-(9), each of which contributes to defining placement of the seeds in the fields 103.

$$ObjSlcPFrc = {\sum }_{i ∈ \vert CreTbl \vert} 10 \times {SlcPFrc}_{i} \qquad ( 1 )$$

where ObjSlcFrc includes slack variable for the product fraction; CreTbl is input data in tuple format; and SlcPFRc is slack variable per placement i.

$$ObjYld = \frac{Min Yld + {\sum }_{i ∈ \vert CreTbl \vert} {Pos}_{i} \times {PrdFrc}_{i}}{Max Yld - Min Yld} \qquad ( 2 )$$

where MinYld is minimum yield; Max Yld is maximum yield; Pos is probability of success, and PrdFrc is fraction of the product.

$$ObjGdPrdFld = 0.5 \times \frac{{\sum }_{i ∈ \vert CreTbl \vert} {Pos}_{i} \times {GrpPrdAvScr}_{i} \times {PrdFrc}_{i} - Min PrdScr}{DiffScr} \qquad ( 3 )$$

where GrpPrdAvScrᵢ is productive average score for the group; MinPrdScr is minimum productivity score; and DiffScr is field score difference (i.e., between the maximum productivity score and the minimum productivity score.)

$$ObjMtrRsk 1 = 10 \times ArmRskMdl \times {\sum }_{i in \vert CreTbl \vert} {PrdFrc}_{i} \times \frac{( F {fkdRsk}_{i} - Min {RskTrsh}_{i} )}{Min {RskTrshDiv}_{i} \times {AermFrc}_{i}} \times {Ffkd Min TrshMtx}_{i} \qquad ( 4 )$$

where ArmRskMdl is maturity risk; FfkdRsk is the AERM risk; MinRskTrsh is minimum risk threshold; MinRskTrshDiv is minimum risk threshold deviation; AermFrc is AERM fraction; and FfkdMinTrshMtx is AERM risk minimum threshold.

$$ObjMtrRsk 2 = 0.3 \times ArmRskMdl \times {\sum }_{i ∈ \vert CreTbl \vert} ( {PrdFrc}_{i} \times \frac{( {FfkdRsk}_{i} - {ArmRskSfeTrsh}_{i} )}{{ArmRskSfeTrshDiv}_{i} \times {AermFrc}_{i}} \times {FfkdSfeTrshMtx}_{i} ) \qquad ( 5 )$$

where ArmRskfeTrsh is AERM risk safe threshold; ArmRskSfeTrshDiv is AERM risk safe threshold deviation; and FfkdSfeTrshMtx is AERM risk safe threshold.

$$ObjMtrRsk 3 = 10 \times ArmRskMdl \times {\sum }_{i ∈ \vert CreTbl \vert} ( {PrdFrc}_{i} \times \frac{( {FfkdRsk}_{i} - {ArmRsk Up Trsh}_{i} )}{{ArmRsk Up TrshDiv}_{i} \times {AermFrc}_{i}} \times {Ffkd Up TrshMtx}_{i} ) \qquad ( 6 )$$

wherein ArmRskUpTrsh is AERM risk upper threshold; ArmRskUpTrshDiv is AERM risk upper threshold deviation; and FfkdUpTrshMtx is AERM risk upper threshold.

$$ObjLateRmExt = 10 \times LateRmBckSlc \qquad ( 7 )$$

$$ObjErlRmExt = 10 \times ErlRmBckSlc \qquad ( 8 )$$

$$ObjPrdCapSlc = 2 \times \frac{PrdCapSlc}{PrdCapDiv} \qquad ( 9 )$$

wherein ObjLateRmExt is late RM bucket exceed limit; LateRmBackSlc is slack variable to obtain feasible solution when total volume in late RM bucket exceed limit; ObjErlRmExt is early RM bucket exceed limit; ErlRmBckSlc is slack variable to obtain feasible solution when total volume in early RM bucket exceed limit; ObjPrdCapSlc is product cap exceed; PrdCapSlc is product cap slack; and PrdCapDiv is product cap deviation.

The objective function is further subject to the following constraints defined in Table 1.

TABLE 1

| Constraints | Description |
|---|---|
| Σ_{i∈ \|CreTbl\|}PrdFrc_{Id[i]} = 1 | sum of volumes adds up to |
| | 100% for portfolio |
| PrdFrc_{Id[i]} ≤ KyGrpPrdFrcᵢ + | product fraction limited by total |
| SlcPFrc_{Id[i]} | fraction inside group where |
| | there is predictions data |
| PrdFrc_{Id[i]} ≤ 5 × PrdUse_{Id[i]} | binary variable 1 if product |
| | selected in feature group, |
| | assume >1 acre fields |
| PrdUse_{Id[i]} ≤ TtlAcr × PrdFrc_{Id[i]} | (PrdFrcᵢ > 0 ≈ PrdUseᵢ = 1) |
| | product_selected_for_key_group |
| PrdInPrt_{Prdc[i]} ≥ PrdUse_{Id[i]} | binary variable 1 if product in |
| | portfolio within >0 volume (if |
| | PrdUseᵢ = 1 → product is in |
| | portfolio rec) |
| Σ_{ocp∈ \|PrdOpc\|}PrdUseOpc_{Id[opc]} × | product used in op cluster |
| CluMrx_{opc, i} × PrdMtx_{opc, i} ≥ | |
| PrdUse_{Id[i]} | |
| MinRmOpc_{Clu[i]} ≤ PrdRMᵢ + 10 × | Min and max RM of a cluster for |
| max(PrdRmLst) × (1 − PrdUse_{Id[i]}) | RM spread requirement this |
| PrdUse_{Id[i]} × PrdRMᵢ ≤ | constraint is active for the 1st |
| MaxRmOpc_{Clu[i]} | problem in algorithm since |
| | products for next set of |
| | subproblems will subset of 1st |
| | problem |

In the above, KyGrpPrdFrc is the key group product fraction which is product x product acre fraction x for each key group level; PrdUse is product selected for a key group; TtlAcr is total acreage; PrdInPrt is product in portfolio; PrdUseOpc is product used in an operational cluster; CluMrx is included cluster rule; PrdMtrx is product match in a product operational cluster tuple; MinRmOpc is minimum RM for an operation cluster; PrdRm is product RM; PrdRmLst is product RM list; and MaxRmOpc is maximum RM for an operational cluster.

The objective function is based on and/or include the following variables defined in Table 2.

TABLE 2
Variables

| Objective | Description |
|---|---|
| PrdFrcᵢ ∈ [0, 1], ∀ i ∈ \|CreTbl\| | Product fraction in core tuple |
| PrdUse_{Id[i]} ∈ {0, 1}, ∀ i ∈ \|CreTbl\| | Product selected for a key group |
| PrdInPrtₚ ∈ [0, 1], ∀ p ∈ \|PrdTbl\| | Product in portfolio |
| PrdUseOpc_{Id[opc]} ∈ [0, 1], ∀ | Product selected for |
| opc ∈ \|OpCls\| | operational cluster |
| RmSlcOpc_{Clu[c]} ∈ [0, 1], ∀ | Slack variable for RM for |
| c ∈ \|OpCls\| | operational cluster |
| MinRmOpc_{Clu[i]} ∈ [0, ∞), ∀ | Minimum RM for |
| i ∈ \|OpCls\| | operational cluster |
| MaxRmOpc_{Clu[i]} ∈ [0, ∞), ∀ | Maximum RM for |
| i ∈ \|OpCls\| | operational cluster |
| ObjSlcPFrc ∈ (−∞, ∞) | Slack variable for each key |
| | group product fraction |
| ObjYld ∈ (−∞, ∞) | Maximizing potential yield |
| ObjGdPrdFld ∈ (−∞, ∞) | Maximizing high performing |
| | products in high performing field |
| ObjMtrRsk1 ∈ (−∞, ∞) | Minimizing maturity risk above |
| | minimum threshold |
| ObjMtrRsk2 ∈ (−∞, ∞) | Minimizing maturity risk above |
| | safe threshold |
| ObjMtrRsk3 ∈ (−∞, ∞) | Minimizing maturity risk above |
| | upper threshold |
| ObjLateRmExt ∈ (−∞, ∞) | Minimizing late RM bucket |
| | exceed limit |
| ObjErlRmExt ∈ (−∞, ∞) | Minimizing early RM bucket |
| | exceed limit |
| ObjPrdCapSlc ∈ (−∞, ∞) | Minimizing product cap exceed |
| ObjPltySlc ∈ (−∞, ∞) | Minimizing penalty for |
| | slack variables |
| ObjPltyOprulSlc ∈ (−∞, ∞) | Minimizing penalty for |
| | operational rule violation |

The objectives are influenced by various ones of the constraints described above, which may be hard constraints, which cannot be violated in a recommendation, or soft constraints, which are associated with a penalty for violation. Generally, constraints may include science constraints, which include hard constraints such as all fields must have assigned products and at least one product per field. Other constraints include, without limitation, products selected for a group key level are less than or equal to a number of fields in a group key; total acres of fields with high corn rootworm (CRW) risk (e.g., a corn-on-corn field, etc.) and without below ground protection traits is greater than or equal to the difference of the units of “below ground trait” needed minus the units of “below ground trait” available; number of bags for a product in a cluster is greater than or equal to a threshold; number of products in a cluster is greater than or equal to a threshold; number of products in a cluster is less than or equal to a number of fields in the cluster; etc.

Still other constraints, generally, may include a difference of minimum and maximum RM in clusters to be less than or equal to a defined threshold. The RM may further be limited, within a cluster, or field 103, for example, based on: (input average RM-RM deviation)≤weighted assigned RM across fields≤input average RM+RM deviation; assigned product's RM≥minimum RM threshold; assigned product's RM≤maximum RM threshold; percentage of products in recommendation for a single RM≤defined threshold; percentage of assigned products with (product RM>preferred RM+1.5)≤defined threshold; percentage of assigned products with (product RM<preferred RM−1.5)≤defined threshold; etc.

Other general constraints may include: for a field, preference against products with below ground protection trait on fields with low CRW risk, total acres of fields with low CRW risk which have below ground protection traits≤defined threshold; number of assigned products≤cap for number of products; number of assigned products>defined threshold for number of products; total violations of assigned products' amounts from their minimum bag requirements≤threshold; total violations of assigned trait percentage from traits' minimum requirement≤defined threshold; all brands of “brand list” should be selected in recommendation; total violations of assigned brand percentage from brands' minimum requirement≤defined threshold; percentage of total acres assigned to a single base hybrid≤maximum threshold; minimum percentage of a single product in a recommendation≥defined threshold; maximum percentage of a single product in a recommendation≤defined threshold; total violations of assigned products' amounts from their supply limits≤defined threshold; total percentage of assigned products in a recommendation with Launch lifestyle≤defined threshold; and percentage of a single product in a recommendation with certain lifecycle≤defined threshold for that product; etc.

Other constraints may be more specifically defined, as provided below. For example, in particular, one example constraint may require that any product selected for an operational cluster must be selected in a quantity to meet the minimum bags requirement, where the quantity may be based on a summation of the product fraction, as defined above, conversion of fractions to bags and product match in product operational cluster tuple relative to the minimum bags, product selected for the operational cluster, as defined above, etc.

Another example constraint may require that a maximum RM speed within the cluster, the speed based on maximum RM for the operational cluster, as defined above, and the minimum RM for the operational cluster, as defined above, be relative to the maximum RM spread and the slack variable for the RM for the operational cluster, as defined above.

Another example constraint may include that product volume for a feature group is selected from across products to cover all acres in the key group, the volume based on, for example but not limited to, the summation of the product fraction, the mast key group and product relative to the key group product fraction and the slack variable that allows a fraction selected to be over the total key group product fraction. Yet another example constraint is corn-on-corn acres of operation covered by products with below ground protection is limited by the units that are available, the amount based on, for example but not limited to, the summation of the slack variable to obtain a feasible solution when the below ground protection is not selected for the CRW high risk fields and CRW risk being “high” relative to the total insect protection trait penalty slack variable and the below ground coverage lower bound.

A further example constraint indicates that the total volume of products without the below ground protection trait is limited, the volume based on, for example but not limited to, the summation of the slack variable to obtain a feasible solution when the below ground protection trait product is selected for low risk fields and the CRW risk being “high” relative to the total no insect protection trait penalty slack variable and the no below ground coverage lower bound. Another example constraint indicates that enough product volume is selected across products to cover all acres in the key group, the volume based on, for example but not limited to, the summation of the product fraction, as defined above, and the key group match being equal to the key group fraction.

Yet another example limits the maximum products for the key group based on the number of fields, the product based on, for example but not limited to, the summation of the product selected for a key group, as defined above, and the key group match relative to the key group number of fields, the slack variable for the cluster product and the 1 product 1 field variable. Another example constraint requires enough below ground protection traited products selected to cover high CRW risk, the products based on, for example but not limited to, the slack variable to obtain a feasible solution when the below ground protection trait product is not selected for CRW high risk fields and insect protection penalty lower bound relative to the key group fraction and the summation of the product fraction, as defined above, and the key group match.

Yet another example constraint requires enough non-below ground protection traited products selected to cover low CRW risk acres, the products based on, for example but not limited to the slack variable to obtain a feasible solution when the below ground protection trait product is selected for low risk fields and no insect protection penalty lower bound relative to the summation of the product fraction, as defined above, and the key group matrix.

Another example constraint requires the total shift from the input brand percentage to be within the allowable deviation, the shift based on, for example but not limited to, the summation of the slack variable to obtain a feasible solution when the brand mix cannot be met within the allowed deviation relative to the brand cap, the slack variable to obtain a feasible solution when the brand mix cannot be met within the allowed deviation and the brand match penalty lower bound.

Yet another example constraint requires that the selected brand percentage in REC should be greater than or equal to the input brand percentage for each trait, the brand percentage based on, for example but not limited to, the summation of the product fraction, as defined above, and the brand match relative to the brand percentage and the slack variable to obtain a feasible solution when the brand mix cannot be met within the allowed deviation.

A still further example constraint requires that if the brand percentage is greater than zero then at least one product of that brand should be chosen, the brand percentage based on, for example but not limited to, the summation of the product selected for a key group, as defined above, and the brand match relative to the slack variable to obtain a feasible solution when the brand mix cannot be met within the allowed deviation. Yet another example constraint requires the trait mix must be within the allowable deviation, the mix based on, for example but not limited to, the summation of the slack variable to obtain a feasible solution when the trait mix cannot be met within the allowed deviations relative to the trait cap, the slack variable to obtain a feasible solution when the trait mix cannot be met within the allowed deviation and the trait match penalty lower bound.

Another example constraint requires the selected trait percentage in the REC should be greater than or equal to the input trait percentage, the percentage based on, for example but not limited to, the summation of the product fraction, as defined above, the trait simplified stack match relative to the trait minimum percentage and the slack variable to obtain a feasible solution when the trait mix cannot be met within the allowed deviation. Yet another example constraint requires the maximum limit on a single base hybrid product RM percentage should be less than the product hybrid cap, the limit based on, for example but not limited to, the summation of the product fraction, as defined above, the base hybrid match relative to the product hybrid cap and the slack variable to obtain a feasible solution when the single base hybrid volume exceeds the upper limit. A further example constraint is based on, for example but not limited to, the summation of the product fraction, as defined above, and the product RM match relative to the RM cap and the slack variable to obtain a feasible solution when the single product RM volume exceeds the upper limit.

Yet another example constraint requires, if a product is selected in any key group, then the product is selected in the recommendation, the product based on, for example but not limited to, the product in the portfolio, as defined above, relative to the summation of the product selected for a key group, as defined above, and the product match in a product operational cluster tuple, and another example constraint requires, if a product is selected in the recommendation, then it must be selected for at least 1 cluster, the product based on, for example but not limited to, the product in the portfolio, as defined above, relative to the summation of the product selected for an operational cluster, as defined above, and the product match in a product operational cluster tuple. Yet another example constraint requires a maximum limit on a single product percentage, the limit based on, for example but not limited to, the summation of the product fraction, as defined above, and the product match in a product operational cluster tuple relative to the product cap and the slack variable to obtain a feasible solution when the maximum launch PCT cap cannot be met.

Yet another example constraint requires a minimum bags requirement for product, the bags based on, for example but not limited to, the summation of the product fraction, as defined above, a conversion of fractions to bags and the product match in a product operational cluster tuple relative to a minimum number of bags in a portfolio, product in the portfolio, as defined above, and the slack variable to obtain a feasible solution when the minimum bags requirement cannot be met. A still further example constraint requires a volume limit on the product recommendation, the volume based on, for example but not limited to, the summation of the product fraction, as defined above, a conversion of fractions to bags and the product match in a product operational cluster tuple relative to the available bags and the slack variable to obtain a feasible solution when the maximum bags limitation cannot be met.

Another example constraint requires the maximum limit on a single launch product percentage, the limit based on, for example but not limited by, the summation of the product fraction, as defined above, the product match in a product operational cluster tuple relative to the launch cap deviation and the slack variable to obtain a feasible solution when the maximum launch PCT CAP cannot be met. Yet another example constraint requires the maximum limit on total launch product percentage, the limit based on, for example but not limited by, the summation of the product fraction, as defined above, the product lifecycle relative to the total launch cap deviation and the total launch cap slack variable.

A still further example constraint requires a total bags minimum requirement must be met, the bags based on, for example but not limited to, the summation of the slack variable to obtain a feasible solution when the minimum bags requirement cannot be met relative to the slack variable to obtain a feasible solution when the product bags requirements is not met and the minimum bags penalty lower bound; and another example constraint requires the total supply cap must not be exceeded, the cap based on, for example but not limited to, the summation of the slack variable to obtain a feasible solution when the maximum bags limitation cannot be met relative to the total supply slack allowed and the slack variable to obtain a feasible solution when the product supply limit requirement is not met.

One further example constraint requires a minimum number of products in the recommendation must be selected; the products based on, for example but not limited to, the summation of the product in the portfolio, as defined above, relative to the minimum products and the slack variable to obtain a feasible solution when the minimum number of products required are not selected. Yet another example constraint requires the number of products in the recommendation is capped at a maximum allowed, the products based on the summation of the product in the portfolio, as defined above, relative to the maximum product and the slack variable to obtain a feasible solution when the maximum number of products cap is exceeded. Another example constraint requires the average RM must be within a recommended range, where the range is based on, for example but not limited to, the summation of the product fraction, as defined above, and the product RM relative to the grower average RM, the average RM deviation and the slack variable to obtain a feasible solution when the average RM required is outside the allowable range.

One other example constraint requires the selected minimum-maximum product RM must stay within minimum-maximum product RM range, the minimum based on, for example but not limited to, the summation of the product selected and the product RM grower minimum match relative to the slack variable to obtain a feasible solution when the product RM is selected outside the lower range, and where the maximum is based on, for example but not limited to, the summation of the product selected, the product RM grower minimum not matching and the product RM grower minimum deviation match relative to the slack variable to obtain a feasible solution when the minimum product RM required is not selected.

Yet another example constraint requires the proper RM spread, the maximum and the minimum, be generated, the minimum for the spread based on, for example but not limited to, the summation of the product fraction, as defined above, and the product RM grower average match relative to the late RM bucket desired max fraction and the slack variable to obtain a feasible solution when the total volume in an early RM bucket exceeds the limit and the maximum spread based on, for example but not limited to, the summation of the product fraction, as defined above, and the product RM grower average that does not match the relative to early RM bucket desired minimum fraction and the slack variable to obtain a feasible solution when the total volume in the early RM bucket exceeds the limit.

It should be appreciated that other constraints may be imposed on the objective function, as necessary of desired for a particular embodiment.

As apparent through the description above, based on the available processing capabilities, the objective function may be accomplished in one cycle or multiple cycles. In one example, the model architecture 200 then includes model 210, which sequentially cycles and progresses by level, from cluster key level, to group key level to field level, as shown in FIG. 2. In particular, to generate a recommendation of field to seeds that respects all the fields 103 and operation specific constraints, multiple optimizations are determined at different scale levels using the same model. Different levels are determined for the fields 103 that fit a unique combination for key groups. Initially, a cluster key level is configured to determine the recommendation based on operational clusters, AERM risk median and corn rootworm (CRW) risk. The operational cluster (which may be optional based on the number and/or size of fields 103) is provided to satisfy cluster related requirements, such as, for example, capacity of planters, size of clusters, distances between fields 103 (e.g., 25 mile limit, etc.), counts per clusters (e.g., boxes, fields, etc.), etc. The AERM risk median is provided to select suitable products for the specific environments of the fields 103, and CRW risk is provided to select suitable products having the right trait for the right field.

At the next level, certain solutions are dropped based on one or more thresholds, and the placement key level is configured to determine the recommendation based on operational clusters, AERM risk median, corn rootworm (CRW) risk and key feature. The key feature is provided to introduce selection of the seed/hybrid for one or more key features. The key features depend on the specific model used above for predicting yield performance. In one example, based on the description of the Elastic Net yield model above, the key features include eight features, which may include, without limitation, previous_crop_class (i.e., previous crop class. 2 classes: Corn, other), mac_zone (i.e., macroenvironment zone (simplified to whole value) (e.g., 11 classes (e.g., 11 classes: West Central, North Central, High Plains, Appalachia, Delta, East Central, South Central, Central, Missouri Territory, North West, Western Territory, etc.), etc.)), segment_name (i.e., product segment for county), texture_class (i.e., SSURGO simplified texture class (depth: 0-0.15 m), (e.g., five classes (i.e., Sands, Loams, Silt Loams, Clay Loams, Clays), etc.)), cec_class (i.e., SSURGO Cation Exchange Capacity (depth: 0-0.15 m) GxE feature), gls_risk (i.e., county grey leaf splot (GLS) risk GXE feature), and nlb_risk (i.e., County Northern Leaf Blight (NLB) risk)). At this level, common groups of fields 103 based on the key features are assigned seeds and volumes of the same.

At the third level, in this example embodiment, certain solutions are dropped based on one or more thresholds, and the field level is configured to select seed(s) for each of the fields 103 from the seeds and volumes assigned to the group of which the field 103 is a member, based on operational clusters, AERM risk median, corn rootworm (CRW) risk, key feature and field identifier.

It should be appreciated that the solutions, or recommendation, at each level are the output of the objective function, which are subject to the constraints described above, as appropriate. In connection therewith, it should be understood that available seeds are eliminated from selection to later fields 103 based on the selections of those seeds in prior fields 103, as limited by the listing of seeds and associated volumes, as described above. It should be further appreciated that one or more constraints may be imposed to limit the consistency of seeds in one or more fields 103, whereby a maximum (and/or minimum) percentage of a field 103 (e.g., 35%, 30%, 25%, etc.) and/or a selection is imposed.

It should be appreciated that the above, and other objectives and/or constraints, as relevant to the specific recommendation, the products (i.e., seeds), fields 103, etc., may be imposed in connection with the model 210, in this example embodiment.

With continued reference to FIG. 2, the model architecture 200 further includes a post process operation 212, which configures the agricultural computer system 116 to select one of the multiple outputs based on predicted yield. That is, the objective function may define a single recommendation for placement of the seeds/volumes in the fields 103, or may provide multiple different recommendations as an output to the objective function (e.g., five, then, etc., best performing or “maximized” recommendation via the objective function, etc.). When only one output or recommendation is attained from the objective function, the lower portion of the architecture 200 may be omitted. When multiple outputs or recommendations are attained, the lower portion of the architecture 200, starting with the selection from the recommendation, at 212, may be retained.

The model architecture 200 includes a field guide operation 214, which configures the agricultural computer system 116, for each field 103, to include multiple seeds for planting in a recommendation in rank-order so that the user 104 is permitted to choose a best ranked alternative when the recommended seed/hybrid is not available (or potentially, in lieu of the recommended seed/hybrid). It should be understood that the field guide operation 214 considers the impact of any potential decisions to not select an optimal seed/hybrid for a specific field to determine ranking of products in a field.

Additionally, the model architecture 200 further includes a recommendation metrics operation 216, which configures the agricultural computer system 116 to compare the recommendation to historical practices of the user 104 in the fields 103. When the recommendation deviates from the historical practices of the grower operation 102, a flag or warning may be issued and/or notation added to the recommendation to the attention of the user 104 or other associated person. The closeness of the recommendation to historical practices may be based on particular products, volumes, etc.

Further, as shown, the model architecture 200 includes a select best recommendation operation 218, which configures the agricultural computer system 116 to select one of the recommendations for the fields 103 based on one or more criteria. In this example embodiment, the post process operation 212 configures the agricultural computer system 116 to select the output based on the predicted yield being within one or more of: a threshold bushels per acre of the other outputs and above a threshold percentage of yield delta potential; less percentage of seeds whose volumes is close to minimum; smallest single product maximum percentage; least percentage of seeds with same volumes; and threshold number of products in the recommendation, etc.

The agricultural computer system 116 is configured, by the model architecture 200, then, to output a recommendation of seed(s) per each of the fields 103 in the grower operation 102.

With reference again to FIG. 1, in this example embodiment, the agricultural computer system 116 is also programmed, or configured, to output the recommendation to the user 104. The recommendation may be provided in a table, in which the predicted yields are included or may be included in an interface along with a basis for the selection, recommendation metrics, field guide information, etc.

The recommendation is then selected by the user 104, via a field manager computing device 110 associated with the user 104. This may include the user 104 ordering and/or purchasing the recommended seeds, for instance, via the agricultural computer system 116, etc. (e.g., whereby the agricultural computer system 116 receives the order, purchase request, etc. from the grower/user, in response to output of the candidate seeds to the grower/user and a corresponding selection by the grower/user; etc.), and then the agricultural computer system 116 directing the recommended seeds to the user 104 (e.g., delivering the selected seeds to the target field, etc.). In addition, the recommended seeds may be planted, by the user 104 or other party, for example, in the fields 103. In doing so, broadly, the recommended seeds are included (e.g., planted, etc.) in the fields 103, by the planting equipment 106a-b, based on one or more scripts generated and/or compiled by the agricultural computer system 116. This may include the agricultural computer system 116 generating planting instructions—as the script(s)—based on the recommended seeds and providing the instructions to the planting equipment 106a-b whereby the planting equipment 106a-b operates, in response to the instructions, to plant the recommended seeds in the fields 103, with only limited additional input from the user 104 (e.g., upon delivery of the selected seeds to the planter, etc.). In one or more embodiments, the planting equipment 106a-b may be controlled automatically, through the scripts generated, by the agricultural computer system 116, in response to the user's 104 selection and/or the identification by the agricultural computer system 116.

The user 104 (e.g., a grower, a sales representative, another user, etc.) in the system 100 may own, operate or possess the field manager computing device 110 in a field location, or associated with a field location, such as in one of the fields 103 intended for agricultural activities or a management location for the fields 103. The field manager computing device 110 is programmed, or configured, to provide field data to the agricultural computer system 116 via one or more networks (as indicated by arrowed lines in FIG. 1). Again, the network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data may include, for example, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) weather data (for example, precipitation, rainfall rate, predicted rainfall, water runoff rate region, temperature, wind, forecast, pressure, visibility, clouds, heat index, dew point, humidity, snow depth, air quality, sunrise, sunset), and (g) other data described herein, etc.

As described, data server 108 is communicatively coupled to the agricultural computer system 116 and is programmed, or configured, to send external data 112 (e.g., data associated with the fields 103 in the grower operation 102, etc.) to the agricultural computer system 116 via the network(s) herein (e.g., for use in recommending seeds for the fields 103 identified by the user 104, etc.). The data server 108 may be owned or operated by the same legal person or entity as the agricultural computer system 116, or by a different person or entity, such as a government agency, non-governmental organization (NGO), and/or a private data service provider. Examples of external data 112 include weather data, imagery data, soil data, seed data and seed selection data as described herein, data from the various fields 103, or statistical data relating to crop yields, among others. The weather data, for example, may include past and present weather data as well as forecasts for future weather data. In an embodiment, data server 108 comprises a plurality of servers hosted by different entities. For example, a first server may contain soil composition data while a second server may include weather data. Additionally, soil data may be stored in multiple servers. For example, one server may store data representing percentage of sand, silt, and clay in the soil while a second server may store data representing percentage of organic matter (OM) in the soil. Further, in some embodiments, the data server 108, again, may include data associated with the fields 103 with regard to available seeds for use in comparisons, etc.

That said, external data 112 may include the same type of information as field data. In some embodiments, the external data 112 may also be provided by data server 108 owned by the same entity that owns and/or operates the agricultural computer system 116. For example, the agricultural computer system 116 may include a data server 108 focused exclusively on a type of data that might otherwise be obtained from third party sources, such as weather data. In some embodiments, data server 108 may actually be incorporated within the agricultural computer system 116.

The system 100 also includes, as described above, planting equipment 106a-b configured to plants one or more seeds in the fields 103. In some examples, the planting equipment 106a-b may have one or more remote sensors fixed thereon, where the sensor(s) are communicatively coupled, either directly or indirectly, via the planting equipment 106a-b to the agricultural computer system 116 and are programmed, or configured, to send sensor data to the agricultural computer system 116.

Additional examples of agricultural (or farm) equipment that may be included in the system 100 include tractors, combines, other harvesters, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the agricultural apparatus may comprise a plurality of sensors that are coupled locally in a network on the apparatus. Controller area network (CAN) is an example of such a network that can be installed in combines, harvesters, sprayers, and cultivators. In connection therewith, then, an application controller associated with the apparatus may be communicatively coupled to the agricultural computer system 116 via the network(s) and programmed, or configured, to receive one or more scripts that are used to control an operating parameter of the agricultural apparatus (or another agricultural vehicle or implement) from the agricultural computer system 116 (e.g., planting instructions generated by the agricultural computer system 116 and transmitted to a planter agricultural apparatus that then control operation of the planter agricultural apparatus to plant certain selected seeds (e.g., in a particular manner, etc.), etc.). For instance, a controller area network (CAN) bus interface may be used to enable communications from the agricultural computer system 116 to the planting equipment 106a-b, for example, such as how the CLIMATE FIELDVIEW DRIVE, available from Climate LLC, of Saint Louis, Missouri, is used. Sensor data may consist of the same type of information as field data. In some embodiments, remote sensors may not be fixed to an agricultural apparatus but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the planting equipment 106a-b in the system 100, data server 108, the agricultural computer system 116, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

The agricultural computer system 116 is programmed, or configured, to receive field data from the field manager computing device 110, external data 112 from an external data server computer 114, and sensor data from one or more remote sensors in the system 100. The agricultural computer system 116 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, the agricultural computer system 116 is programmed with or comprises a communication layer 1032, a presentation layer 1034, a data management layer 1040, a hardware visualization layer 1050, and a model and field data repository layer 1060. “Layer,” in this context, refers to any combination of electronic digital interface circuits, microcontrollers, firmware, such as drivers, and/or computer programs, or other software elements.

The communication layer 1032 may be programmed, or configured, to perform input/output interfacing functions including sending requests to the field manager computing device 110, data server 108, and remote sensor(s) for field data, external data 112, and sensor data respectively. The communication layer 1032 may be programmed, or configured, to send the received data to the model and field data repository layer 1060 to be stored as field data (e.g., in the agricultural computer system 116, etc.).

The presentation layer 1034 may be programmed, or configured, to generate a graphical user interface (GUI) to be displayed on the field manager computing device 110 (e.g., for use in interacting with the agricultural computer system 116 to identify fields 103, recommended seeds, predicted yields, etc.) or other computers that are coupled to the agricultural computer system 116 through the network(s). The GUI may comprise controls for inputting data to be sent to the agricultural computer system 116, generating requests for models and/or recommendations, and/or displaying recommendations, notifications, models, and other field data.

The data management layer 1040 may be programmed, or configured, to manage read operations and write operations involving the model and field data repository layer 1060 and other functional elements of the system, including queries and result sets communicated between the functional elements of the system and the repository. Examples of the data management layer 1040 include JDBC, SQL server interface code, and/or HADOOP interface code, among others. The model and field data repository layer 1060 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data is not provided directly to the agricultural computer system 116 via one or more agricultural machines or agricultural machine devices that interact with the agricultural computer system 116, the user 104 may be prompted via one or more user interfaces on the field manager computing device 110 (served by the agricultural computer system 116) to input such information for use in effecting the selections herein.

In an example embodiment, the agricultural computer system 116 is programmed to generate and cause displaying of a graphical user interface comprising a data manager for data input. After one or more fields have been identified using the methods described above, the data manager may provide one or more graphical user interface widgets which when selected can identify changes to the field, soil, crops, tillage, or nutrient practices, and/or which may provide comparison data related to target seed identified by the user 104 and candidate seeds identified by the disclosure herein for the field(s) 103. The data manager may include a timeline view, a spreadsheet view, a graphical view, and/or one or more editable programs.

In an embodiment, model and field data is stored in the model and field data repository layer 1060. Model data comprises data models created for one or more fields 103. For example, a crop model may include a digitally constructed model of the development of a crop on the one or more fields 103. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields 103, a model of the current status of the one or more fields 103, and/or a model of predicted events on the one or more fields 103. Model and field data may be stored in data structures in memory, rows in a database table, in flat files or spreadsheets, or other forms of stored digital data.

With further reference to FIG. 1, in an embodiment, instructions 1035 of the agricultural computer system 116 may comprise a set of one or more pages of main memory, such as RAM, in the agricultural computer system 116 into which executable instructions have been loaded and which when executed cause the agricultural computer system 116 to perform the functions or operations that are described herein. For example, the instructions 1035 may comprise a set of pages in RAM that contain instructions which, when executed, cause performing the seed identification functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 1035 also may represent one or more files or projects of source code that are digitally stored in a mass storage device, such as non-volatile RAM or disk storage, in the agricultural computer system 116 or a separate repository system, which when compiled or interpreted cause generating executable instructions which when executed cause the agricultural computer system 116 to perform the functions or operations that are described herein. In other words, the drawing figure may represent the manner in which programmers or software developers organize and arrange source code for later compilation into an executable, or interpretation into bytecode or the equivalent, for execution by the agricultural computer system 116.

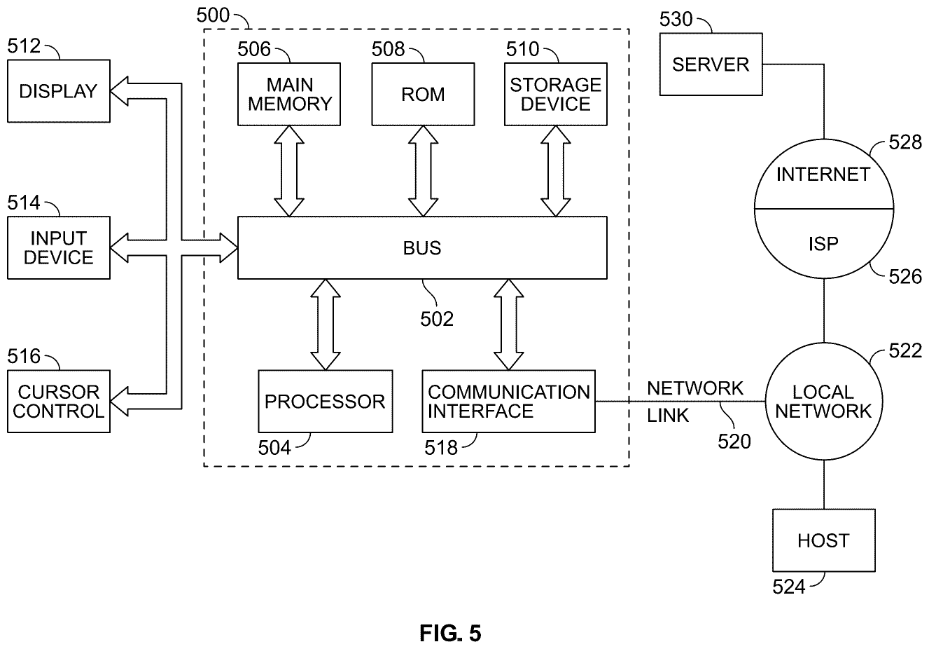

The hardware visualization layer 1050 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 5. The hardware visualization layer 1050 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 110 associated with different users. Further, the agricultural computer system 116 and/or data server 108 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, the user 104 interacts with the agricultural computer system 116 using the field manager computing device 110 configured with an operating system and one or more application programs or apps. The field manager computing device 110 also may interoperate with the agricultural computer system 116 independently and automatically under program control or logical control and direct user interaction is not always required. The field manager computing device 110 broadly represents one or more of a smart phone, PDA, tablet computing device, laptop computer, desktop computer, workstation, or any other computing device capable of transmitting and receiving information and performing the functions described herein. The field manager computing device 110 may communicate via a network using a mobile application stored on the field manager computing device 110, and in some embodiments, the device may be coupled using a cable or connector to one or more sensors and/or other apparatus in the system 100. A particular user 104 may own, operate or possess and use, in connection with system 100, more than one field manager computing device 110 at a time.

The mobile application associated with the field manager computing device 110 may provide client-side functionality, via the network to one or more mobile computing devices. In an example embodiment, the field manager computing device 110 may access the mobile application via a web browser or a local client application or app. The field manager computing device 110 may request data from, transmit data to, and receive data from, one or more front-end servers, using web-based protocols, or formats, such as HTTP, XML and/or JSON, or app-specific protocols. In an example embodiment, the data may take the form of requests and user information input, such as field data, into the mobile computing device. In some embodiments, the mobile application interacts with location tracking hardware and software on the field manager computing device 110 which determines the location of the field manager computing device 110 using standard tracking techniques, such as multilateration of radio signals, the global positioning system (GPS), WiFi positioning systems, or other methods of mobile positioning. In some cases, location data or other data associated with the field manager computing device 110, user 104, and/or user account(s) may be obtained by queries to an operating system of the field manager computer device 110 or by requesting an app on the field manager computer device 110 to obtain data from the operating system.

In an embodiment, in addition to other functionalities described herein, the field manager computing device 110 sends field data to the agricultural computer system 116 comprising or including, but not limited to, data values representing one or more of: a geographical location of the one or more fields 103, tillage information for the one or more fields 103, crops planted in the one or more fields 103, and soil data extracted from the one or more fields 103. The field manager computing device 110 may send field data in response to user input from the user 104 specifying the data values for the one or more fields 103. Additionally, the field manager computing device 110 may automatically send field data when one or more of the data values becomes available to the field manager computing device 110. For example, the field manager computing device 110 may be communicatively coupled to a remote sensor in the system 100, and in response to an input received at the sensor, the field manager computing device 110 may send field data to the agricultural computer system 116 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the field manager computing device 110 may also be stored as external data 112 (e.g., where the field data is collected as part of harvesting crops from the grower operation 102, etc.), for example, in the data server 108.

A commercial example of the mobile application is CLIMATE FIELDVIEW, commercially available from Climate LLC, Saint Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

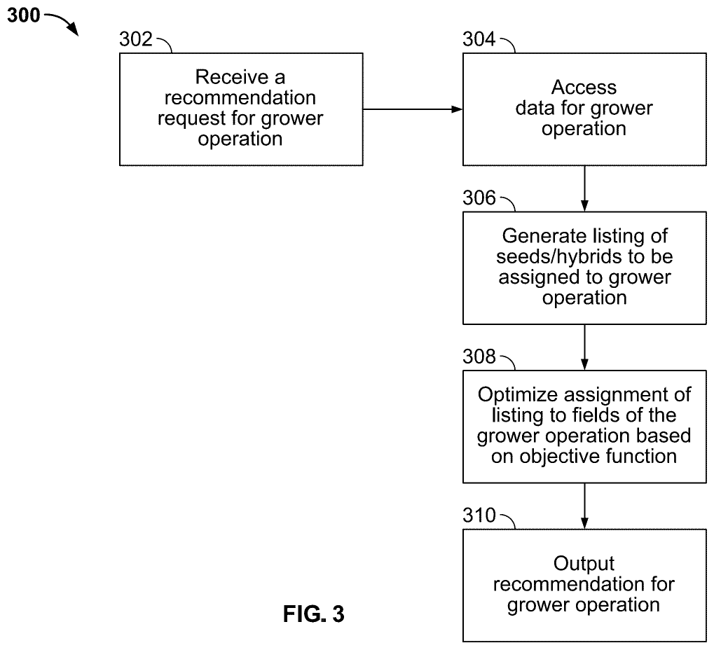

FIG. 3 illustrates an example method 300 for recommending seeds to be planted in numerous fields. The example method 300 is described herein in connection with the system 100, and may be implemented, in whole or in part, in the agricultural computer system 116 of the system 100. However, it should be appreciated that the method 300, or other methods described herein, are not limited to the system 100 or the agricultural computer system 116. And, conversely, the systems, data structures, and the computing devices described herein are not limited to the example method 300.

At the outset, in method 300, the user 104 requests, at 302, a recommendation for which seeds to be planted in the fields 103, which is generally defined as a grower operation 102. The grower operation 102 generally includes the fields 103 for the grower to be planted in the particular season. In addition, the request includes any associated preferences of the grower (e.g., user 104, etc.), such as, for example, brand (e.g., brand channel, brand region, etc.), grower relative maturity (e.g., maximum, minimum, average, deviations, spread, etc.), volumes, ratio, and/or number of products (e.g., minimum number of products, minimum volume, maximum product ratio, etc.), seeding rates, brand and/or trait deviation, insect risk rotation, traits (e.g., insect ground protection (e.g., above and/or below ground, etc.), conventional, etc.), rotation, remainder inventory of products, etc.

At 304, the agricultural computer system 116 accesses relevant data from the data servers 108. The accessed data may include, as explained above, data related to the fields 103 included in the grower operation 102, environmental data, data related to the seeds, etc.

In response to the request, at 306, the agricultural computer system 116 generates a listing of seeds to be planted in the fields 103. The listing is based on the performance of the particular seeds in the respective ones of the fields 103. The performance is generally categorized herein as a yield performance, and the calculation of the performance is based on a modeling of the genetic makeup of the seeds relative to the anticipated environmental features of the fields 103. The environmental features generally include weather conditions and/or soil conditions. The weather conditions include, for example, without limitations, peak temperatures, average temperatures, low temperatures, humidity, hours of daylight, precipitation, etc., associated with the fields 103. The soil conditions generally include, for example, without limitation, elevation, textures, CEC data, etc.

The listing, in this exemplary embodiment, includes between one and ten of the seeds for each of the fields 103, in rank order based on performance, as explained above.

Next, at 308, the agricultural computer system 116 optimizes the placement of the seeds in the listing into each of the fields 103. The agricultural computer system 116 leverages the objective function described above, along with ones of the constraints on the optimization function. In doing so, the agricultural computer system 116 assigns the seeds from the listing to the particular fields 103 and defines a volume of the seeds to be planted in the particular field 103.

At 310, the agricultural computer system 116 provides the recommendation for the grower operation 102 to the user 104 (in response to the request for the recommendation.

In doing so, the agricultural computer system 116 may output the recommendation to the user 104, through electronic mail or through a mobile application included in the field manager computing device 110. The field manager computing device 110 may then display the recommendation to the user 104 for review thereby and also, in response to an input from the user 104 (or automatically), execute the recommendation by directing the planting of the appropriate seeds in the respective ones of the fields 103 of the grower operation 102 consistent with the recommendation. In at least one embodiment, to provide the recommendation, the agricultural computer system 116 generates a script and transmits the script to the agricultural equipment 106a-b. In turn, the agricultural equipment 106a-b executes the script to plant one or more of the fields 103 consistent with the recommendation.

In this way, as explained above with reference to the agricultural equipment 106a-b, the agricultural computer system 116 includes the seeds from the planting recommendation in the fields 103 of the grower operation 102.

It should be appreciated that the planting recommendation may be provided by the agricultural computing system 116 in one or more other manners to provide for convenient review by the user 104 and/or execution of the recommendation by the agricultural equipment 106a-b in the fields 103.

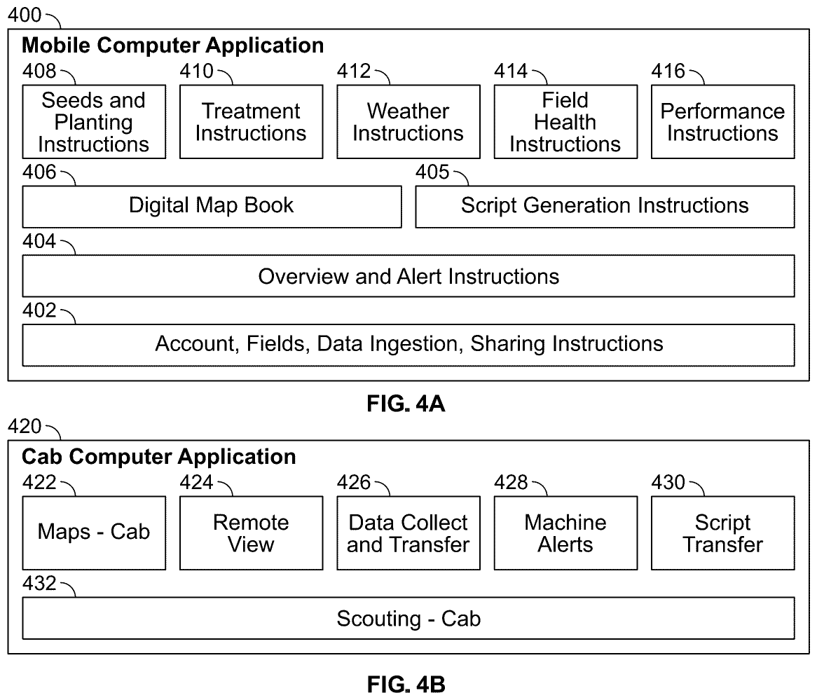

FIGS. 4A and 4B illustrate two views of an example logical organization of sets of instructions in main memory when an example mobile application is loaded for execution. In FIGS. 4A and 4B, each named element represents a region of one or more pages of RAM or other main memory, or one or more blocks of disk storage or other non-volatile storage, and the programmed instructions within those regions. In one embodiment, in FIG. 4A, a mobile computer application 400 comprises account, fields, data ingestion, sharing instructions 402, overview and alert instructions 404, digital map book instructions 406, seeds and planting instructions 408, treatment instructions 410, weather instructions 412, field health instructions 414, and performance instructions 416.

In one embodiment, a mobile computer application 400 comprises account, fields, data ingestion, sharing instructions 402 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, the mobile computer application 400 comprises a data inbox. In response to receiving a selection of the data inbox, the mobile computer application 400 may display a graphical user interface for manually uploading data files and importing uploaded files to a data manager.

In one embodiment, digital map book instructions 406 comprise field map data layers stored in device memory and are programmed with data visualization tools and geospatial field notes. This provides growers with convenient information close at hand for reference, logging and visual insights into field performance. In one embodiment, overview and alert instructions 404 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 408 are programmed to provide tools for seed selection, hybrid placement, and script creation, including variable rate (VR) script creation, based upon scientific models and empirical data. This enables growers to improve and/or maximize yield or return on investment through optimized seed purchase, placement and population.

In one embodiment, script generation instructions 405 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, the mobile computer application 400 may display one or more fields 103 broken into management zones, such as the field map data layers created as part of digital map book instructions 406. In one embodiment, the management zones comprise soil zones along with a panel identifying each soil zone and a soil name, texture, drainage for each zone, or other field data. The mobile computer application 400 may also display tools for editing or creating such, such as graphical tools for drawing management zones, such as soil zones, over a map of one or more fields 103. Planting procedures may be applied to all management zones or different planting procedures may be applied to different subsets of management zones. When a script is created, the mobile computer application 400 may make the script available for download in a format readable by an application controller, such as an archived or compressed format. Additionally, and/or alternatively, a script may be sent directly to a cab computer from the mobile computer application 400 and/or uploaded to one or more data servers 108 and stored for further use.

In one embodiment, treatment instructions 410 are programmed to provide tools to inform treatment decisions by visualizing the availability of treatments to crops. This enables growers to improve and/or maximize yield or return on investment through the parameters of certain treatments (e.g., nitrogen, fertilizer, fungicides, other nutrients (such as phosphorus and potassium), pesticide, and irrigation, etc.) applied during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others.

“Mass data entry,” in this context, may mean entering data once and then applying the same data to multiple fields and/or zones that have been defined in the system; example data may include treatment application data that is the same for many fields 103 and/or zones of the same grower, but such mass data entry applies to the entry of any type of field data into the mobile computer application 400. For example, treatment instructions 410 may be programmed to accept definitions of application and practices programs and to accept user input specifying to apply those programs across multiple fields 103. For example, “nitrogen application programs,” in this context, refers to stored, named sets of data that associates: a name, color code or other identifier, one or more dates of application, types of material or product for each of the dates and amounts, method of application or incorporation such as injected or broadcast, and/or amounts or rates of application for each of the dates, crop or hybrid that is the subject of the application, among others. Such “nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Treatment instructions 410 also may be programmed to generate and cause displaying of a treatment graph, which indicates projections of plant use of the specified treatment and whether a surplus or shortfall is predicted; in some embodiments, different color indicators may signal a magnitude of surplus or a magnitude of shortfall. In one embodiment, a treatment graph comprises a graphical display in a computer display device comprising a plurality of rows, each row associated with and identifying a field 103; data specifying what crop is planted in the field 103, the field size, the field location, and a graphic representation of the field perimeter; in each row, a timeline by month with graphic indicators specifying each treatment applied and amount at points correlated to month names; and numeric and/or colored indicators of surplus or shortfall, in which color indicates magnitude.

In one embodiment, the treatment graph may include one or more user input features, such as dials or slider bars, to dynamically change the treatment planting and practices programs so that a user 104 may alter the treatment graph. The user 104 may then use his treatment graph and the related treatment planting and practices programs to implement one or more scripts, including variable rate (VR) fertility scripts. Treatment instructions 410 also may be programmed to generate and cause displaying of a treatment map, which indicates projections of plant use of the specified treatment and whether a surplus or shortfall is predicted; in some embodiments, different color indicators may signal a magnitude of surplus or a magnitude of shortfall. The treatment map may display projections of plant use of the specified treatment and whether a surplus or shortfall is predicted for different times in the past and the future (such as daily, weekly, monthly or yearly) using numeric and/or colored indicators of surplus or shortfall, in which color indicates magnitude. In one embodiment, the treatment map may include one or more user input features, such as dials or slider bars, to dynamically change the treatment planting and practices programs so that a user 104 may alter his treatment map, such as to obtain a preferred amount of surplus to shortfall. The user 104 may then use his optimized treatment map and the related treatment planting and practices programs to implement one or more scripts, including variable rate (VR) fertility scripts.

In one embodiment, weather instructions 412 are programmed to provide field-specific recent weather data and forecasted weather information. This enables growers to save time and have an efficient integrated display with respect to daily operational decisions.

In one embodiment, field health instructions 414 are programmed to provide timely remote sensing images highlighting in-season crop variation and potential concerns. Example programmed functions include cloud checking, to identify possible clouds or cloud shadows; determining indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 416 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 416 may be programmed to communicate via the network(s) to back-end analytics programs executed at the agricultural computer system 116 and/or the data server 108 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer. For example, referring now to FIG. 4B, in one embodiment a cab computer application 420 may comprise maps-cab instructions 422, remote view instructions 424, data collect and transfer instructions 426, machine alerts instructions 428, script transfer instructions 430, and scouting-cab instructions 432. The code base for the instructions of FIG. 4B may be the same as for FIG. 4A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 422 may be programmed to provide map views of fields 103, farms or regions that are useful in directing machine operation. The remote view instructions 424 may be programmed to turn on, manage, and provide views of machine activity in real-time or near real-time to other computing devices connected to the agricultural computer system 116 via wireless networks, wired connectors or adapters, and the like. The data collect and transfer instructions 426 may be programmed to turn on, manage, and provide transfer of data collected at sensors and controllers to the agricultural computer system 116 via wireless networks, wired connectors or adapters, and the like. The machine alerts instructions 428 may be programmed to detect issues with operations of the machine or tools that are associated with the cab and generate operator alerts. The script transfer instructions 430 may be configured to transfer in scripts of instructions that are configured to direct machine operations or the collection of data. The scouting-cab instructions 432 may be programmed to display location-based alerts and information received from the system 116 based on the location of the field manager computing device 110, agricultural equipment 106a-b, or sensors in the field 103 and ingest, manage, and provide transfer of location-based scouting observations to the agricultural computer system 116 based on the location of the agricultural equipment 106a-b or sensors in the field 103.

For example, FIG. 5 is a block diagram that illustrates a computer system 500 upon which one or more embodiments of the present disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), liquid crystal display (LCD), light emitting diode (LED), etc., for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device may, for example, have two degrees of freedom in two axes, a first axis (e.g., x, etc.) and a second axis (e.g., y, etc.), that allows the device to specify positions in a plane. The input device 514, more generally, includes any device through which the user is permitted to provide an input, data, etc., to the computer system 500.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infrared data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 430 might transmit a requested code for an application program through Internet 528, ISP 526, local network 522 and communication interface 518.

The received code may be executed by processor 504 as it is received, and/or stored in storage device 510, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the steps/operations recited in the claims.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying candidate seeds, the computer-implemented method comprising:
receiving, from a user, at a computer system, a request for a seed recommendation for a plurality of fields;
identifying, by the computer system, multiple seeds and volumes for the multiple seeds to be planted in the plurality of fields, the multiple seeds included in a rank-ordered listing of ones of the multiple seeds for each of the plurality of fields;
generating, by the computer system, a planting recommendation to plant the multiple seeds from the listing in the plurality of fields as a planting recommendation, based on an objective function, the objective function indicative of yield, multiple relative maturity thresholds, and one or more operational rules;
outputting, by the computer system, the planting recommendation of the seeds to the user associated with the fields, in response to the request; and
including at least one seed from the planting recommendation in one of the plurality of fields.

2. The computer-implemented method of claim 1, wherein the plurality of fields includes hundreds of acres.

3. The computer-implemented method of claim 1, further comprising clustering the plurality of fields based on distances between ones of the plurality of fields.

4. The computer-implemented method of claim 3, wherein the clustering is further based on size of the ones of the plurality of fields.

5. The computer-implemented method of claim 1, wherein the objective function includes:
$$max \{ - ObjSlcPFrc + ( ObjYld + ObjGdPrdFld - ObjMtrRsk 1 - ObjMtrRsk 2 - ObjMtrRsk 3 - Obj Late RmExt - ObjErlRmExt - ObjPrdCapSlc ) - ObjPltySlc - ObjPltyOprulSlc \} .$$

6. The computer-implemented method of claim 1, wherein generating the planting recommendation is based on:
clustered groups of the plurality of fields, AERM risk median, and CRW risk at a key level of the multiple levels; and
clustered groups of the plurality of fields, the AERM risk median, the CRW risk, and the key feature at a group key level of the multiple levels; and
clustered groups of the plurality of fields, the AERM risk median, the CRW risk, the key feature, and the field identifier for the multiple fields at a field level.

7. The computer-implemented method of claim 1, wherein the planting recommendation includes multiple of the seeds in the one of the plurality of fields.

8. The computer-implemented method of claim 1, wherein including the at least one seed in the one of the plurality of fields incudes planting, by a planting device executing the planting recommendation, the at least one seed in the one of the plurality of fields.

9. The computer-implemented method of claim 1, further comprising comparing the planting recommendation to historical practices of the user in the plurality of fields; and
wherein outputting the planting recommendation includes outputting the planting recommendation in response to the planting recommendation being within one or more threshold(s) of the historical practices of the user.

10. A non-transitory computer readable storage medium including executable instructions, which when executed by at least one processor, cause the at least one processor to:
receive from a user, via a field manager computing device associated with the user, a request for a seed recommendation for planting in a plurality of fields;
identify multiple seeds and volumes for the multiple seeds to be planted in the plurality of fields, the multiple seeds included in a rank-ordered listing of ones of the multiple seeds for each of the plurality of fields;
generate a planting recommendation to plant the multiple seeds from the listing in the plurality of fields as a planting recommendation, based on an objective function, the objective function indicative of yield, multiple relative maturity thresholds, and one or more operational rules;
output the planting recommendation of the seeds to the user, at the field manager computing device, in response to the request;
receive a selection of the planting recommendation from the user, via the field manager computing device; and
in response to the selection, cause at least one seed from the planting recommendation to be planted in one of the plurality of fields.

11. The non-transitory computer readable storage medium of claim 10, wherein the objective function includes:
$$max \{ - ObjSlcPFrc + ( ObjYld + ObjGdPrdFld - ObjMtrRsk 1 - ObjMtrRsk 2 - ObjMtrRsk 3 - Obj Late RmExt - ObjErlRmExt - ObjPrdCapSlc ) - ObjPltySlc - ObjPltyOprulSlc \} .$$

12. A system for use in identifying candidate seeds, the system comprising:
at least one processor; and
a memory in communication with the at least one processor, the memory storing executable instructions, which when executed by the at least one processor, cause the at least one processor to:
receive from a user, via a field manager computing device associated with the user, a request for a seed recommendation for planting in a plurality of fields;
identify multiple seeds and volumes for the multiple seeds to be planted in the plurality of fields, the multiple seeds included in a rank-ordered listing of ones of the multiple seeds for each of the plurality of fields;
generate a planting recommendation to plant the multiple seeds from the listing in the plurality of fields as a planting recommendation, based on an objective function, the objective function indicative of yield, multiple relative maturity thresholds, and one or more operational rules;
output the planting recommendation of the seeds to the user, at the field manager computing device, in response to the request;
receive a selection of the planting recommendation from the user, via the field manager computing device; and
in response to the selection, cause at least one seed from the planting recommendation to be planted in one of the plurality of fields.

13. The system of claim 12, wherein the plurality of fields includes hundreds of acres.

14. The system of claim 12, wherein the executable instructions, when executed by the at least one processor, further cause the at least one processor to cluster the plurality of fields based on distances between ones of the plurality of fields.

15. The system of claim 14, wherein the executable instructions, when executed by the at least one processor, cause the at least one processor to cluster the plurality of fields further based on a size of the ones of the plurality of fields.

16. The system of claim 12, wherein the objective function includes:
$$max \{ - ObjSlcPFrc + ( ObjYld + ObjGdPrdFld - ObjMtrRsk 1 - ObjMtrRsk 2 - ObjMtrRsk 3 - Obj Late RmExt - ObjErlRmExt - ObjPrdCapSlc ) - ObjPltySlc - ObjPltyOprulSlc \} .$$

17. The system of claim 12, wherein the executable instructions, when executed by the at least one processor, cause the at least one processor to generate the planting recommendation further based on:
clustered groups of the plurality of fields, AERM risk median, and CRW risk at a key level of the multiple levels;
clustered groups of the plurality of fields, the AERM risk median, the CRW risk, and the key feature at a group key level of the multiple levels; and/or
clustered groups of the plurality of fields, the AERM risk median, the CRW risk, the key feature, and the field identifier for the multiple fields at a field level.

18. The system of claim 12, wherein the planting recommendation includes multiple of the seeds in the one of the plurality of fields.

19. The system of claim 12, wherein the executable instructions, when executed by the at least one processor, further cause the at least one processor to compare the planting recommendation to historical practices of the user in the plurality of fields; and
wherein the executable instructions, when executed by the at least one processor, cause the at least one processor to output the planting recommendation in response to the planting recommendation being within one or more threshold(s) of the historical practices of the user.

20. The system of claim 12, wherein the executable instructions, when executed by the at least one processor, cause the at least one processor to transmit the planting recommendation to a cab computer of a planting device in response to the selection of the planting recommendation from the user; and
wherein the system further comprises executable planting device instructions, which when executed by the cab computer of the planting device in response to the planting recommendation, cause the planting device to plant the at least one seed in the one of the plurality of fields.
